(19) United States
(12) Patent Application Publication
(10) Pub. No.: US 2006/0115615 A1
(43) Pub. Date: Jun. 1, 2006

(54) At least two-layer film with at least one layer composed of thermoplastic polyurethanes, and use thereof for soil-warming of soils utilized for agriculture

(76) Inventors: Dirk Schultz, Walsrode (DE); Antoine Cassel, Walsrode (DE); Thomas S. Weisse, South Hampton, MA (US)

Correspondence Address: BAYER MATERIAL SCIENCE LLC, 100 BAYER ROAD, PITTSBURGH, PA, 15205, US

(21) Appl. No.: 10/999,636

(22) Filed: Nov. 30, 2004

(51) Int. Cl. B29C 47/00

(52) U.S. Cl. 428/36.9

(57) ABSTRACT

A composite film comprising at least two-layers of film is described. This film is suitable for soil-warming, and comprises at least one first layer of film comprising one or more thermoplastic polyurethanes and at least one second layer of film comprising one or more hydrocarbon polymers. This film is also described as being suitable for soil-warming of soils that are utilized for agriculture such as, e.g., for the solar sterilization of the soil.

### BACKGROUND OF THE INVENTION

This invention relates to composite films comprising at least two-layers of thermoplastic films. More specifically, these composite films comprise at least one layer composed of thermoplastic polyurethane, and at least one layer composed of thermoplastic hydrocarbon polymers. The present invention also relates to a process for soil-warming under insolation with these composite films.

By combining a layer of urethane polymers and a layer of hydrocarbon polymers it is possible to provide properties that are needed for soil-warming and that cannot be produced from the individual layers of either type of polymer.

Nowadays, various agricultural processes use plastic films, in transparent form to permit the passage of light for plant growth, in pigmented form to selectively block or transmit wavelengths of light, or which are completely opaque or actually reflective film to inhibit the growth of, for example, weeds. It is possible to reduce the maximum soil temperature which can be reached, e.g. via pigmentation (black mulch). Besides the use of films to influence light-related conditions, they are also used to adjust the temperature of the soil and its moisture levels.

Commonly used processes encompass the covering of greenhouses, the sterilization of soils by sunlight-induced warming, and also-mulching applications.

Greenhouse films can be installed on relatively large greenhouse structures, or they may be stretched over a number of rows of plants in the form of a walk-through tunnel, or, in a smaller tunnel design, they may span individual rows of plants, or they may be used for a forcing bed. Greenhouse films are characterized by high transparency and an ability to retain heat in the air space around the plants. They are preferably used in areas or at times that otherwise are too cold for high-productivity agriculture. The result can be an increase in the ambient temperature of the protectively covered plants, thus lengthening the planting and/or growing season.

Soil sterilization by means of sunlight-induced warming, also termed solar sterilization, is a process for suppressing or actually eliminating soil-associated plant pests. In the prior art, the soil is first moistened and then protectively covered with transparent polyethylene sheeting. Soil warming takes place via direct irradiation by sunlight. In this process, the warming of the soil is often insufficient to achieve an effective reduction in the number of pests, or the necessary period of exposure to sunlight reduces the planting season available for productive use. This technology has been known for quite a long time, as described by way of example, by H. R. Hagan in Soil Science 36 (1933) 83-95, in relation to trials using a cellophane film. However, cellophane films have disadvantages in mass production and in the production of high-laid width materials.

Biomass or synthetic chemicals intended for soil sterilization may be thermally activated. Agricultural films in combination with biomass or synthetic chemical can improve the effect of soil sterilization used for cultivation.

By way of example, prior-art protective covering films for agricultural applications are manufactured from polyethylene or polyvinyl chloride or their copolymers or mixtures thereof. Specific films which are presently found in the market are composed of branched low-density polyethylene (LDPE), linear low-density polyethylene (LLDPE), ethylene-vinyl acetate copolymers, ethylene-butyl acrylate copolymers, or their mixtures.

Depending on the additives used and the final application, the agricultural market makes distinctions based on transparency and scattering: high-transmittance, normal-transmittance, scattering and opaque or opaque-colored. Only the latter have any effect on weed growth, as set out by way of example in EP-A 0398243.

A disadvantage of films composed of these raw materials is the low level of excitability in the infrared wavelength region. For example, California Codes of Regulations 3055-3055.6 allow these films only for packed soil materials, because this is the only context in which the sterilization conditions considered to be necessary, i.e. 70° C. for 30 minutes or 60° C. for 60 minutes, are achieved.

The use of long-lived fluorinated polymer films has also been reported for this application. High cost and environmental concerns are disadvantages of such fluorinated polymer films.

Mulch film applications are characterized in that the desired plants grow through holes in the films or between film webs. The films here can achieve a high soil temperature, stabilize soil moisture level for the root system, and minimize weed growth. This has been described in EP-A 0 398 243. EP-A 0603680 and EP-A 1 028 619 describe the distribution of a mixture of colorants into individual functional layers in such films. A higher soil temperature can increase yield. If the temperatures under the agricultural films are too high they can be controlled via small slits or holes.

The underlying processes appear to be a heat-induced increase in the mobility of inorganic and organic nutrients and elimination of heat-sensitive pests.

Single-layer films composed of thermoplastic polyurethanes (hereinafter termed TPUs), production processes for these, and also their use, are known from the prior art, as described in, for example, EP-A 0 308 683, EP-A 0 526 858, EP 0 571 868, and EP-A 0 603 680. The structures described in these specifications can be integrated as relatively high-melting layer or layers in double layer films, or have previously been integrated into the double layer films of known type. The production of TPU films using substantially incompatible polymers as matting agents in TPU elastomers have also been described in, e.g. DE-A 41 26 499.

Single-layer films composed of aliphatic polyurethanes have been marketed with the trade name Texin® on the basis of their high luminous transmittance, but have disadvantages in their intrinsic tack and the resultant dust adhesion.

Films composed of TPU exhibit interactions in the infrared (IR) wavelength region of interest, which corresponds to the greatest intensity from a black source. TPUs also have high strengths, both in the ISO 527 tensile test and in the DIN 53515 tear-propagation test.

Depending on the isocyanates used, TPUs may have either aliphatic or aromatic character.

TPUs usually have a block structure or segment structure. A distinction is made in principle between the hard segments which are formed from short-chain diols and the diisocyanates used for the reaction, and the soft segments.

The properties contributed to the TPUs by the hard segments include strength and the maximum service temperatures. Examples of suitable diisocyanates are diphenylmethane 4,4′-diisocyanate, hydrogenated or saturated diphenylmethane 4,4′-diisocyanate, and also tolylene 2,4-diisocyanate. Examples of suitable short-chain diols are 1,4-butanediol, 1,6-hexanediol, ethylene glycol and diethylene glycol.

Soft segments are produced from the reaction of isocyanate functional groups with polymeric diols, the molecular weights of which typically range from 500 to 3000. The properties which they contribute to the material are elastic properties and low-temperature flexibility.

A distinction is usually made between two main groups, polymeric ethers and esterdiols. Among the ethers are polytetrahydrofuran, polyethylene oxide and polypropylene oxide and their copolymers. Among the esters are in particular the adipates: 1,4-butanediol adipate and 1,6-hexanediol adipate, and also co-condensates.

Single-layer films composed of TPU have proven to be disadvantageous, however, because their high strength is a disadvantage during slitting and perforation. The high cost of raw materials is another hindrance. In addition, their intrinsically tacky surface, tending to block, has high dust affinity and can therefore counteract the properties needed such as, for example, high luminous transmittance, which can however be controlled to some extent by the inclusion of suitable additives. However, the desirable modification of wetting-related properties, such as surface tension, is restricted by chemical interactions, and in particular, by molecular weight degradation of the TPUs in the presence of antifogging additives.

Under insolation, TPUs tend to behave as relatively soft materials, and this is particularly disadvantageous for ease of handling in fields.

Another unhelpful property is the high mechanical strength which adversely effects the perforation performance of TPUs.

By way of example, EP-A 0 434 411 describes two-layer coextrudates composed of polyethylene and terpolymer resins which are suitable for lamination to crosslinked polyurethane foams if they comprise unsaturated carboxylic acid monomers and maleic anhydride monomers in addition to the main monomer ethylene. However, because the structure has two layers, the Vicat softening point of the terpolymers described as adhesion-promoting substances in EP-A 0 434 411 cannot be below 80° C. In addition, the production requires two stages which generates high manufacturing costs. Furthermore, polyurethane foams have inadequate strength for the relining process. Foams lack sufficient resistance, specifically in terms of abrasion resistance.

DE-A 23 11 365 describes the production of multilayer films from polyurethanes and hydrocarbon polymers. However, the resultant films produced from polyolefins and polyurethanes by the blown film process are not composite films. The hydrocarbon polymer layer here is coextruded together with the polyurethane film as a release layer to eliminate heat-induced adhesion or blocking of the polyurethane film, either to plant components or to itself. This release layer is peeled away again not later than during the processing of the polyurethane film, to which it is only loosely attached, because bond strength is only low.

The composite structures described in EP-A 024 08 86 are composed of stretched polyolefins and thermoplastic polyurethanes. These have adequate bond strength at low layer thicknesses, but this is not transferable to film structures with greater layer thicknesses. The layer thicknesses described in EP-A 024 08 86 of a few μm for stretched films are markedly lower than what is desirable for significant absorption in the IR region of the spectrum.

Other film structures disclosed by DE-A 19 602 751 are known for use as internal liners for pipe renovation. They encompass multilayer structures composed of polyolefins, thermoplastic polyurethanes and adhesion-promoter components. It is described here that addition of a low-molecular-weight resin of non-waxy character, either of the naturally occurring or the synthetic type, can significantly improve the adhesion properties of a homo-, co- or terpolymer. Resins of this type are described by way of example in Ullmanns Enzyklopädie der technischen Chemie [Ullmann's Encyclopaedia of Industrial Chemistry], Volume 12, 4th Edition, Verlag Chemie, Weinheim 1976, pp. 525-555. Resins of this type usually have an average molar mass below 2000 g/mol. The resins, both those which are solid at room temperature and those which are liquid, are usually non-crystallisable, and therefore, do not have a sharp melting point. In contrast, the materials understood to be low-molecular-weight resins have a softening point determinable by the ball and ring method according to ASTM E-28 or DIN 1995. These resins can reduce melt viscosity, and the result can be a significantly more homogeneous melt. As a result of the flowability improvement on addition of the low-molecular-weight resins, films with outer layers composed of co- or terpolymers which are intrinsically soft have the disadvantage of having very smooth surfaces which thus give the films a tendency to block. Without sheets of release material, films with outer layers modified in this way would block on the reel. The structures mentioned in EP-A 0 434 411 are unsuitable for this type of modification.

### SUMMARY OF THE INVENTION

An object of the present invention was to provide a film suitable for soil-warming by means of protective covering with film, where, together with high luminous transmittance, the heat emission is reduced so as to give a high temperature in the soil area under the film.

According to data published by Y. Mahrer and J. Katan in Soil Science 131 (1981) 82-87, there is a need for laid widths of at least 400 mm in these protective coverings, because lower laid widths can only achieve significantly lower soil temperatures.

The present invention provides a composite film which comprises at least two-layers of film for soil-warming. This composite film comprises (1) at least one first film layer which is comprised of one or more thermoplastic polyurethanes, and (2) at least one second film layer which comprises one or more hydrocarbon polymers and, optionally, (3) a layer comprising at least one polymer adhesion promoter which is located between the first and second layers of film.

The present invention makes it possible to combine the properties that are typical of olefin materials, that is the desirable properties of ability to be perforated (i.e. perforability), dirt repellency, chemical suitability for long-term stability and contact with antifogging agents, with the heat-barrier characteristics that are typical of TPUs. In order to minimize manufacturing costs, films exhibiting these properties can be prepared in a single-stage process.

The inventive composite films also have very good suitability as a protective covering in order to warm agricultural soil, with the result being the elimination of pests (i.e. soil sterilization).

The present invention also succeeded in providing a film that complies with the requirements previously mentioned for soil-warming and which heats the soil used in agriculture under insolation, with the film being composed of at least two layers, where one of the two or more layers is composed of at least one thermoplastic polyurethane and the second is composed of at least one hydrocarbon polymer or at least one hydrocarbon copolymer.

The film of the present invention also overcomes the above mentioned disadvantages of soil-warming with an improved method of warming of soils under cultivation by means of multilayer composite films composed of at least two different thermoplastic resin materials with a total thickness of from 25 to 200 μm, in which at least one resin of these multilayer films comes from the thermoplastic polyurethanes group and at least one resin of these multilayer films comes from the hydrocarbon polymers group.

In preferred embodiments, the width of inventive film webs is at least 40 cm. According to the invention, it is preferred that the prepared films have a total unfolded laid width (which width is transverse to the direction of running of the machine) of greater than 400 mm, and particularly preferably from at least about 1600 mm to about 3200 mm.

Preferred TPU resins for the present invention are those materials whose soft segments mainly have an ether structure. These soft segments more preferably comprise copolymers comprised of ether units composed of polytetrahydrofuran and/or polyethylene oxide.

According to the invention, preference is given to a multilayer composite film which comprises at least one film layer comprised of TPU ethers.

The Shore hardness of the films of this invention is preferably in the range from 80 Shore A to 50 Shore D.

In one preferred embodiment of the process, between the film layer comprised of thermoplastic polyurethanes and the film layer comprised of hydrocarbon polymers, there may be at least one other intermediate layer which is formed from an olefin-based polymer adhesion promoter. Suitable olefin-based polymer adhesion promoters comprise maleic anhydride as a reaction component in the formulation and those whose Vicat softening point, measured according to ASTM D1525, is below 70° C.

According to the present invention, it is preferred that adhesion promoters which are used as the intermediate layer between the two outer layers of film are characterized by having a Vicat softening range, measured according to ASTM D1525, at temperatures below 60° C.

Copolymers of ethylene with maleic anhydride and with esters of c,o-monounsaturated alcohols or carboxylic acids are also preferred for producing the adhesion promoter layer. In particular, these are copolymers composed of ethylene and acrylates, methacrylates or vinyl acetate.

In one particularly preferred embodiment, the adhesion-promoting components which form the intermediate layer between the film of hydrocarbon polymers and the film of thermoplastic polyurethane polymers are characterized by a structure that is at least comprised of the comonomers ethylene and maleic anhydride, in which, based on the total weight of the adhesion-promoting substance used for film production, the proportion of maleic anhydride is less than 6% by weight.

To achieve the low Vicat softening point in accordance with the invention, preference is given to the use of adhesion-promoting components which comprise chloroform-extractable, low-molecular-weight resins as reaction components of the formulation.

In particular, preference is given to chloroform-extractable, low-molecular-weight resins which improve the adhesive properties of the adhesion-promoting component in such a way as to yield very good bond strength. Furthermore, addition of the resin alters the phase behaviour of the adhesion promoter component. As a result, the softening point is lowered, and thus improves elasticity and flexibility.

By way of example, low-molecular-weight resins suitable for the present invention may be derived from the substance classes of the naturally occurring and/or synthetic resins.

Examples of naturally occurring resins are: asphaltites, balsams, pine balsams, non-fossil resins, fossil resins, colophonium, colophonium derivatives and/or shellac. Examples of synthetic resins are: aliphatic or aromatic hydrocarbon resins, partially or fully hydrogenated hydrocarbon resins, modified hydrocarbon resins, indene-coumarone resins, furan resins, ketone resins, and also polyamide resins. Said of low-molecular-weight resins are available on the market, e.g. under the trade name Escorez or Fural.

Preference is given to those resins whose softening point is below 100° C., measured according to ASTM E-28 or DIN 1995 using ball and ring.

One film layer of the present multilayer composite film comprises at least one thermoplastic polyurethane elastomer, and preferably a mainly linear thermoplastic polyurethane elastomer. This thermoplastic polyurethane elastomer comprises one or more longer-chain diol component that is a polyester or polyether, and preferably the Shore hardness of this component ranges from about 75 Shore A to about 95 Shore A, and more preferably from about 85 Shore A to about 95 Shore A, as determined according to DIN 53 505.

Said suitable thermoplastic polyurethanes are commercially available, e.g. under the trade names Desmopan, Elastollan, Pellethane, Estane, Morthane or Texin.

According to the present invention, the preferred materials for forming the film layer comprising TPUs are those TPUs with an ether based soft segment structure. It is particularly preferred that the ether-based soft segment contain a predominance of polytetrahydrofuran fractions, but also suitable are those made of polyethylene oxide fractions.

In addition to the film layer of thermoplastic polyurethane, the multilayer composite film of the present invention comprises at least one layer which comprises at least one hydrocarbon polymer. In one particularly preferred embodiment, this second film layer comprises at least one olefin polymer resin selected from the group consisting of
A) polyethylene (i.e. PE), and
B) polybutylene.

Any hydrocarbon polymer with a Shore D hardness value below 50 (Shore D), as determined according to DIN 53 505, also has excellent suitability for the second layer of film of the multilayer composite films of the present invention.

Another suitable embodiment of the inventive film is obtained by using hydrocarbon polymers which comprise any copolymers from the group of styrene-olefin copolymers. These copolymers are suitable for the outer layer of film comprising one or more hydrocarbon polymers. Examples of suitable styrene-olefin copolymers are commercially available block copolymers like styrene-butadiene-styrene, styrene-ethylene/butadiene-styrene and styrene-isoprene/butadiene-styrene, e.g. under the trade names Kraton, Cariflex, Carilon or Styrolux.

In one possible embodiment of the invention, these multilayer composite films also comprise, in at least one of the layers comprising thermoplastic polyurethane polymers, one or more of the familiar additives for thermoplastic polyurethanes selected from the group consisting of:
(I) antiblocking agents, inorganic or organic separator materials,
(II) lubricants or mold-release agents,
(D) pigments or fillers, and
(IV) stabilizers.

The known additives which may be present in the present films are described, by way of example, by Gächter and Müller in: Kunststoff-Additive [Plastics Additives], Carl Hanser Verlag Munich, 3rd Edition (1989).

An additional improvement in the present films in terms of their use and/or ability for soil-warming is achieved if or when further suitable additives selected from the group consisting of the IR (infra-red) absorbers, wetting modifiers, light stabilizers, are added to the matrix resin compositions of the films in the present invention. One preferred additive is kaolin. Preferred wetting modifiers are those selected from the group of the surface-tension-modifying antifogging agents and antidrip agents. These two additive groups may be added to all of the film layers of the present multilayer composite films of the invention. In particularly preferred embodiments, they are added to the outer layer of film which is facing toward the ground.

Since cyclic condensation of water molecules on the film of the inventive process cannot be excluded in the course of daily light-intensity cycles, one preferred embodiment of the film adds or applies at least one antifogging additive which modifies the surface tension of the film used in the process. If the surface tension of the film is high, the condensing water can readily spread on the surface of the film. The objective of this is to produce maximum-size condensate droplets, or ideally, a continuous film that does not scatter or reflect the incident sunlight.

Preferred antifogging additives or antidrip additives include, for example, those which are commercially available under the trade name Atmer 400, and which are selected from the non-ionic surfactants group of substances. Important classes of raw materials encompass glycerol esters, sorbitol esters, and also their ethoxylation products, or ethoxylation products of primary amides, such as erucamide, oleamide or stearylamide.

In one particularly preferred embodiment of the present invention, the wetting modifier is added to the outer layer of film which is comprised of hydrocarbon polymers, because olefins have reliable long-term compatibility with non-ionic surfactants.

Exposure to irradiation can age plastics and also alter their properties. Thus, it has proven particularly suitable to include a system of stabilization with respect to ageing caused by light and UV radiation. The effectiveness of the inventive processes is also improved by reducing, for example, yellowing. UV stabilizers selected from the group consisting of the sterically hindered amines, benzophenone and benzotriazoles have proven suitable according to the invention.

Suitable embodiments of the inventive films may be colored. According to the present invention, preference is given to homogeneous coloring of at least one layer of film. It is particularly preferred that the coloring be homogeneous green coloring.

In one particularly preferred embodiment, the inventive film comprises at least three differently pigmented layers, with at least one outer layer of film being pigmented yellow, and the other layer of film being pigmented blue, and at least one inner layer in this preferred embodiment containing white pigments.

According to the invention, preference is given to multilayer composite films whose total thickness is from about 25 μm to about 200 μm.

In the multilayer composite films of the invention, the thickness of the first film layer (1) comprising thermoplastic polyurethanes is preferably in the range of from 10 μm to 100 μm, the thickness of the adhesion promoter layer (3) is preferably in the range of from 5 μm to 50 μm, and the thickness of the second film layer (2) comprising hydrocarbon polymer is preferably in the range of from 10 μm to 100 μm.

The familiar processes of processing plastics to give multilayer sheet structures via thermal forming are particularly suitable for producing the present multilayer composite films.

Mention may be made here of production of these films via coextrusion, preferably using the blown film process. Among the suitable production processes for multilayer thermoplastic sheet structures, particular preference is given to coextrusion because it can achieve better bond strength.

The surface properties of one or both sides of the inventive films may be modified using the known methods of physical and chemical treatment, such as, for example, corona treatment.

The present invention also provides a process for the use of these films described above for soil-warming in agriculture areas, and in particular, for what is known as solar sterilization. Solar sterilization means warming of the soil via insulation to temperatures above 38° C.

In the course of this aspect of the invention, the films are laid out on the agricultural soil prior to a planting operation, and they remain there for their service life. Solar sterilization generally requires temperatures above 38° C. for a prolonged period, but mulch-film applications may also be productive even at lower temperatures. The soils are preferably watered prior to laying-out of the film, but in the case of existing irrigation systems, the watering may also take place after soil-covering.

According to the present invention, particular preference is given to the use of the films described above for soil-warming in which two or more film layers located at a minimum distance from one another cover the soil, thus permitting formation of an insulating air cushion between the films.

The film used in the inventive process may be slit or perforated prior to, during, or after laying-out on the soil. These slits or perforations can assist in temperature control, or they may be useful for process purposes, such as the introduction of plants into the soil beneath the film.

The blown film extrusion process was used to produce the films described in the following inventive examples and comparative examples. The construction of the screw-based equipment suitable for kneading thermoplastic resins is described, by way of example, by Wortberg, Mahlke and Effen in: Kunststoffe, 84 (1994) 1131-1138, and by Pearson in: Mechanics of Polymer Processing, Elsevier Publishers, New York, 1985, and by Davis-Standard in: Paper, Film & Foil Converter 64 (1990) pp. 84-90. Suitable equipment for extruding the melt to give films is described, inter alia, by Michaeli in: Extrusions-Werkzeuge [Extrusion Dies], Hanser Verlag, Munich 1991.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

### Inventive Example A

Two-layer blown film equipment was used to produce a film having one outer layer (1) formed from a commercially available ether based TPU (thermoplastic polyurethane) having a Shore A hardness of 87, as measured according to DIN 53 505, which corresponds to a hardness of about 33 Shore D. The usual additives, including separator materials and waxes, were added to this layer having a thickness of 25 μm. All of the components for this layer were melted together in an extruder.

The other outer layer (2) was formed from polyethylene. The low-pressure polyethylene had a density of 0.920 g/cm³ and a melt flow index (MFI) of 2 g/10 min, as measured according to DIN 53 735 at 190° C. with a test load of 2.16 kg. The components for forming this layer having a thickness of 25 μm composed of hydrocarbon polymers, e.g. antifogging agent and UV stabilizer, were plastified using another extruder.

The extruders were operated at temperatures of from 160° C. to 200° C. The two melt streams were mutually superposed in a two-layer blown film head at a processing temperature of 195° C., and discharged through an annular die with a diameter of 500 mm. Air was blown onto the melt bubble to cool it and it was then collapsed, and cut, and the separated film webs of 1600 mm width were wound separately.

For soil-warming, the PE side was laid out in contact with the soil.

### Inventive Example B

A three-layer blown film die was used to produce a three-layer film. The first outer layer (1) was formed from a commercially available ether based TPU (thermoplastic polyurethane) having a Shore A hardness of 87, as measured according to DIN 53 505, which corresponds to a hardness of about 33 Shore D. The usual additives, including separator materials and waxes, were added to this layer having a thickness of 25 μm. All of the components used for this layer were melted together in an extruder.

The second outer layer (2) was formed from polyethylene. The low-pressure polyethylene had a density of 0.920 g/cm³ and a melt flow index (MFI) of 2g/10 min, as measured according to DIN 53 735 at 190° C. with a test load of 2.16 kg. The components needed to form the layer having a thickness of 25 μm composed of hydrocarbon polymers, e.g. antifogging agent and UV stabilizer, were plastified using another extruder.

The adhesion promoter which formed the 6 μm middle layer (3) between the first and second film layers as described above had an MFI of 1.3 g/10 min, as measured according to DIN 53 735 at 190° C. with a test load of 2.16 kg. This adhesion-promoting component was synthesized from the monomers ethylene, vinyl acetate and maleic anhydride. Its melting point was 70° C. and the Vicat softening point as measured according to ASTM D 1525 was 52° C. Its density was 0.93 g/cm³.

The extruders were operated at temperatures of from 160° C. to 200° C. The three melt steams were mutually superposed in a three-layer blown film head using a processing temperature of 190° C. and discharged through an annular die with a diameter of 130 mm. Air was blown onto the melt bubble to cool it, and it was then collapsed, and cut, and the separated film webs of 400 mm width were wound up separately.

For soil-warming, the PE side was laid out in contact with the soil.

### Comparative Example 1

A single-layer film composed of polyethylene was produced with a structure similar to that described in Inventive Example A. For this example, both extruders were supplied with a low-pressure polyethylene having a density of 0.920 g/cm³ and a melt flow index (MFI) of 2 g/10 min, as measured according to DIN 53 735 at 190° C. with a test load of 2.16 kg. The other components, such as, e.g. antifogging agent and UV stabilizer, were included in the extruders. The resultant film had a thickness of about 50 μm and a laid width of about 1600 mm.

### Comparative Example 2

A single-layer film composed of polyethylene was produced with a structure similar to that described in Inventive Example B. For this example, both extruders were supplied with a low-pressure polyethylene with a density of 0.920 g/cm³ and a melt flow index (MFI) of 2 g/10 min, as measured according to DIN 53 735 at 190° C. with a test load of 2.16 kg. The other components, such as antifogging agent and UV stabilizer, were also included in the extruder. The total film thickness of 51 μm was obtained at 400 mm width.

### Comparative Example 3

Single-layer blown film equipment was used to produce a single-layer film composed of TPU ester, with the film being composed of a commercially available ester based TPU (thermoplastic polyurethane) having a Shore A hardness of 93, as measured according to DIN 53 505, which corresponds to a hardness of about 49 Shore D. The usual additives, such as, for example, separator materials and waxes, were added to this layer for a thickness of 49 μm. All of the components of this film were melted together in an extruder.

The extruders were operated at temperatures of from 160° C. to 200° C. The melt stream was extruded in a blown-film head using a processing temperature of 190° C. and discharged through an annular die with a diameter of 750 mm. Air was blown onto the melt bubble to cool, and it was then collapsed, and cut, and the separated film webs of 1600 mm width were wound separately.

### Comparative Example 4

A single-layer film composed of TPU ether having a Shore A hardness of 87, which corresponds to a 33 Shore D hardness, was produced by a method similar to that described in Comparative Example 3. The film having a thickness of 50 μm was obtained with a laid width of 1605 mm.

To evaluate the films produced in the inventive examples and comparative examples, tensile performance was tested according to ISO 527, the thickness according to ISO 4593 and the width according to ISO 4592.

The soil temperature was determined after 5 days of cyclic exposure to light as the average value of the daily cycle for various soil depths. Associated features relevant to the application, e.g. wetting performance/dust adhesion and perforability, were determined by comparative subjective assessments. Perforation properties are important, if the film is used for mulching type set up to avoid the growth of weeds. Dust adhesion is important, if films are intended for multiple use set up and are not immediately disposed. Wetting characteristics are significant, as they are key to prevent burned spots on plants caused by water drops. The range of indications given in Table 1 for these three properties regarding their suitability for use in accordance in the present invention is as follows:

| | |
|---|---|
| ++ | very good |
| + | good |
| o | suitable |
| − | not sufficient |
| −− | not acceptable. |

The table (Table 1) below provides characteristic data for the films produced in the examples and comparative examples, and their suitability for use in a process for soil-warming. This data clearly shows that the inventive films described in the inventive examples are more advantageous than the films described in the comparative examples.

TABLE 1
Properties of the films produced in the inventive examples and comparative examples

| | | | | | Comparative | Comparative | Comparative | Comparative |
|---|---|---|---|---|---|---|---|---|
| | Determination | | Inventive | Inventive | Example 1 | Example 2 | Example 3 | Example 4 |
| Property | Method | Units | Example A | Example B | (PE) | (PE) | (TPU Ester) | (TPU Ester) |
| Thickness | ISO 4593 | μm | 50 | 51 | 50 | 50 | 49 | 50 |
| Width | ISO 4592 | mm | 1600 | 800 | 1600 | 400 | 1600 | 1605 |
| Breaking | ISO 527 | N | 54 | 56 | 31 | 29 | 72 | 55 |
| force | | | | | | | | |
| Tensile strain | ISO 527 | % | 430 | 500 | 600 | 700 | 550 | 600 |
| @ break | | | | | | | | |
| Soil Temp. | | ° C. | 48 | 46 | 44 | 41 | 47 | 50 |
| 10 cm | | | | | | | | |
| Soil Temp. | | ° C. | 44 | 43 | 42 | 40 | 44 | 45 |
| 20 cm | | | | | | | | |
| Soil Temp. | | ° C. | 39 | 38 | 38 | 36 | 39 | 40 |
| 40 cm | | | | | | | | |
| Perforability | | | + | + | + | + | −− | − |
| Dust | | | ++ | + | + | + | − | ◯ |
| adhesion* | | | | | | | | |
| Wetting* | | | + | + | + | − | − | + |

*on the side facing the soil

Table 1 clearly shows that the multilayer film structures as described in the inventive examples (Examples A and B) are superior to the single-layer structures presented in the comparative examples (Examples 1-4) in relation to handling properties, while achievable soil temperatures are similar if not identical. Taking into account the lower laid width, the particularly preferred multilayer films with adhesion promoter layer can potentially achieve the highest soil temperatures. The inventive examples overcome the detrimental superior mechanical characteristics of plain urethane, which limit the perforability. They also allow for good wetting characteristics and thus for limited burned spot on the leaves covered by the films.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A composite film having at least two-layers and which comprises (1) at least one first layer of film comprising one or more thermoplastic polyurethanes, and (2) at least one second layer of film comprising one or more hydrocarbon polymers, and, (3) optionally, a layer comprising at least one polymer adhesion promoter located between the first and second layers of film.

2. The film of claim 1, wherein (3) said layer comprising at least one polymer adhesion promoter which is located between the first and second film layers is an olefin-based polymer adhesion promoter which comprises maleic anhydride as a reaction component.

3. The film of claim 2, wherein the proportion of the maleic anhydride as a reaction component for the synthesis of the adhesion-promoting substance is less than 6% by weight, based on the total weight of the polymer adhesion promoter.

4. The film of claim 1, in which the thermoplastic polyurethanes comprise copolymers based on ether units comprising polytetrahydrofuran and/or polyethylene oxide.

5. The film of claim 1, in which at least one of the first or second outer layers of film comprises one or more additives which modify wetting.

6. The film of claim 1, in which (2) the second layer of film comprising one or more hydrocarbon polymers comprises one or more polyolefins selected from the group consisting of polyethylene and/or polybutylene.

7. The film of claim 1, in which (2) the second layer of film which comprises one or more hydrocarbon polymers comprises one or more copolymers which is a styrene-olefin copolymer.

8. The film of claim 1, in which the total thickness of the film having at least two layers is from 25 μm to 200 μm, the thickness of the first outer layer of film comprising one or more thermoplastic polyurethanes is from 10 μm to 100 μm, the thickness of the second outer layer of film comprising one or more hydrocarbon polymers is from 10 Am to 100 μm, and the thickness of the optional adhesion promoter layer is from 5 μm to 50 μm.

9. The film of claim 1, which is present in the form of webs or unfolded tubular films, and has a minimum laid width of 400 mm, as measured in accordance with ISO 4592.

10. The film of claim 1 which it exhibits a Shore hardness in the range of from 80 Shore A to 50 Shore D.

11. A process for the warming of soils for agriculture comprising applying a protective covering to soil, wherein the protective covering comprises the composite film of claim 1, and heating the soil by insulation.

12. A process for sterilization of soil comprising (1) moistening the soil, (2) applying a protective covering to soil, wherein the protective covering comprises the composite film of claim 1, and (3) heating the soil by insulation to a temperature greater than 38° C.
